(19) United States
(12) Patent Application Publication
(10) Pub. No.: US 2010/0271257 A1
(43) Pub. Date: Oct. 28, 2010

(54) Radar apparatus

(76) Inventors: Yuji Hirogari, Nagaokakyo-shi (JP); Motoi Nakanishi, Nagaokakyo-shi (JP)

Correspondence Address: DICKSTEIN SHAPIRO LLP, 1633 Broadway, NEW YORK, NY, 10019, US

(21) Appl. No.: 11/655,843

(22) Filed: Jan. 22, 2007

Related U.S. Application Data
(63) Continuation of application No. PCT/JP05/12305, filed on Jul. 4, 2005.

(30) Foreign Application Priority Data
Aug. 6, 2004 (JP) JP 2004-231175

(51) Int. Cl. G01S 13/66

(52) U.S. Cl. 342/107

(57) ABSTRACT

To prevent erroneous tracking of a false target, increase reliability of target tracking, enhance continuous tracking of a real target, and thereby prevent erroneous target recognition and improve the recognition accuracy, a target is tracked on the basis of detection information that is included in detection information obtained at a plurality of different measurement time points and is estimated to have resulted from one and the same reflector; tracking reliability indicating a likelihood that a target currently being tracked has resulted from one and the same reflector is determined; and a recognition condition required for recognizing a real target is set according to the tracking reliability or its change.

### CROSS REFERENCE TO RELATED APPLICATIONS

The present application is a continuation of International Application No. PCT/JP2005/012305, filed Jul. 4, 2005, which claims priority to Japanese Patent Application No. JP2004-231175, filed, Aug. 6, 2004, the entire contents of each of these applications being incorporated herein by reference in their entirety.

### FIELD OF THE INVENTION

The present invention relates to a radar apparatus for detecting and tracking a target.

### BACKGROUND OF THE INVENTION

An on-vehicle radar apparatus is required not only to provide the capability of detecting the distances and speeds of a plurality of reflectors in a detection area, but also, for the safety of the vehicle and other vehicles, to provide the capability of tracking a necessary target selected from a plurality of targets obtained from detection information resulting from the plurality of reflectors and noise. Such a tracking capability basically involves, from a plurality of targets detected at each measurement period, repeatedly detecting a target to be tracked or extracting a target already being tracked and thereby allowing continuous tracking.

However, when a target corresponding to a reflector in a predetermined detection area is detected and is to be tracked, there is a possibility of erroneous tracking where intangible'targets (hereinafter referred to as “false targets”) resulting from noise, as well as a tangible target (hereinafter referred to as “real target”) such as a vehicle required to be tracked, are erroneously tracked due to a reduced reception-signal strength and the effect of noise. In known processing developed to prevent such erroneous tracking and improve reliability and continuity of target tracking, a probability that a target is detected at the same position in every measurement period is determined. Then, if the probability exceeds a predetermined threshold value, the target is regarded as a target corresponding to a tangible reflector.

For example, Patent Document 1 discloses a technique in which “the degree of certainty” is determined by comparing a target position detected by measurement with a target position already stored. If it is determined that these positions correspond to each other, the degree of certainty is increased. If it is determined that these positions do not correspond to each other, the degree of certainty is decreased. Then, if the degree of certainty remains below a predetermined threshold value, that is, if a “missed” state continues for a long period of time, data relating to the target is deleted from a storage unit.

Patent Document 2 discloses a technique in which if a target is successfully detected, at an intended position, N times out of M times of detecting operation (“N-out-of-M value”), the target is regarded as a target currently being tracked.

Patent Document 3 discloses a technique in which the “likelihood” of being a preceding vehicle is calculated. In this technique, a vehicle candidate point group is detected depending on whether there are a plurality of measured points at substantially the same relative distance and across a width corresponding to a vehicle width. Then, by using functions, such as the number of vehicle candidate points and the distance between measured points at the respective ends of the width, the likelihood of being a preceding vehicle is calculated.

Patent Document 4 discloses a technique in which, in an FM-CW radar apparatus, pairing is performed if a difference between peak values of sharp mountain-like projecting portions of an upbeat signal and a downbeat signal (hereinafter simply referred to as “projecting portions”) appearing on a frequency axis is equal to or less than a predetermined value, while pairing is not performed if the difference exceeds the predetermined value. Thus, tracking of a false target can be prevented.

Patent Document 5 discloses a technique in which peaks located at the same relative distance, each peak appearing at a predetermined angle corresponding to an angular difference between a side lobe and the peak position of the central main lobe, are regarded as virtual images resulting from side lobes.

Patent Document 6 discloses a technique in which a moving target existing in the area of a group of continuous stationary objects is regarded as a false target resulting from mispairing.

Patent Document 1: Japanese Patent No. 3065821

Patent Document 2: Japanese Patent No. 3242603

Patent Document 3: Japanese Patent No. 3002354

Patent Document 4: Japanese Unexamined Patent Application Publication No. 4-343084

Patent Document 5: Japanese Patent No. 3447234

Patent Document 6: Japanese Unexamined Patent Application Publication No. 2003-177178

“The degree of certainty” disclosed in Patent Document 1 is used only in determining the presence of a target. The degree of certainty thus cannot be used as a measure for reliable determination (or target recognition) as to whether a target to be tracked or a target currently being tracked is a real target or a false target.

“N-out-of-M value” disclosed in Patent Document 2 is also used only in determining the presence of a target, and thus cannot be used as a measure for reliable target recognition.

“Likelihood” disclosed in Patent Document 3 is used only in determining the driving lane of a preceding vehicle. Thus, “likelihood” cannot improve the accuracy of the target recognition described above.

The FM-CW radar apparatus disclosed in Patent Document 4 can prevent mispairing and thus can improve overall pairing accuracy, accordingly. However, pairing is performed consistently under the same conditions regardless of the possibility that noise may have caused the projecting portions to appear in the frequency spectrum. Therefore, if there is a large amount of noise, the possibility of performing pairing on noise cannot be reduced. Thus, reliability of target tracking cannot be improved. Moreover, if a projecting portion derived from a real target and observed in the frequency spectrum is located in an area where the effect of noise is significant, pairing cannot be performed continuously. This results in reduced continuity of tracking of a real target.

An apparatus disclosed in Patent Document 5 attempts to recognize a virtual image resulting from a side lobe, even with respect to a projecting portion appearing in the frequency spectrum due to noise, consistently under the same conditions. Therefore, the reliability of target tracking and the accuracy of target recognition cannot be improved.

In an apparatus disclosed in Patent Document 6, the area of a group of continuous stationary objects is fixed. Therefore, the effect of noise increases the occurrence of mispairing and decreases the reliability of target tracking.

### SUMMARY OF THE INVENTION

An object of the present invention is to provide a radar apparatus that can prevent erroneous tracking of a false target, improve reliability of target tracking and continuity of real-target tracking, and thereby prevent erroneous target recognition and improve accuracy in target recognition.

To solve the problems described above, a radar apparatus of the present invention is configured as follows.

(1) A radar apparatus includes a detection information obtaining unit for obtaining detection information including information about a position or a speed of a reflector in a predetermined detection area by transmitting and receiving an electromagnetic wave to and from the detection area at each predetermined measurement time point; a tracking reliability determining unit for tracking a target corresponding to a reflector on the basis of detection information that is included in the detection information obtained by the detection information obtaining unit at a plurality of different measurement time points and is estimated to have resulted from one and the same reflector, and for determining tracking reliability indicating a likelihood that the target currently being tracked has resulted from the one and the same reflector; and a recognition condition setting unit for setting a recognition condition such that the recognition condition required for recognizing a real target is tightened if the tracking reliability is low or if an increasing tendency of the tracking reliability is not observed.

(2) The recognition condition is an allowable variation range of the position and speed of a target at each measurement time point. The allowable variation range is used for determining whether the target is one and the same target.

(3) The electromagnetic wave is a frequency modulated continuous wave. The detection information obtaining unit obtains information about response signals generated in a frequency spectrum of beat signals in an ascending modulation section and a descending modulation section of a reception signal and a transmission signal of the electromagnetic wave. The detection information obtaining unit includes a pairing element for determining a pair of response signals on the basis of a pairing condition for determining whether the response signals generated in the ascending modulation section and the descending modulation section have resulted from the same reflector, and a measured value calculating element for calculating a position and speed of the reflector on the basis of the pair of the response signals determined by the pairing element. The recognition condition is the pairing condition.

(4) The radar apparatus further includes a clustering unit for processing, as a single cluster, a plurality of pieces of detection information regarded as having resulted from the same reflector, on the basis of a clustering condition which at least defines positional proximity to one another. The recognition condition is the clustering condition.

(5) The radar apparatus further includes a side-lobe processing unit for processing, as a virtual image, detection information included in the detection information obtained by the detection information obtaining unit, derived from one and the same reflector, and resulting from a side lobe of an antenna capable of transmitting and receiving the electromagnetic wave. The recognition condition is a condition for determining the virtual image by the side-lobe processing unit.

(6) The electromagnetic wave is a frequency modulated continuous wave. The detection information obtaining unit includes an element for obtaining information about projecting portions observed in a frequency spectrum of beat signals generated in an ascending modulation section and a descending modulation section of a reception signal and a transmission signal of the electromagnetic wave; a pairing element for determining a pair of response signals on the basis of a pairing condition for determining whether the response signals generated in the ascending modulation section and the descending modulation section have resulted from the same reflector; a measured value calculating element for calculating a position and speed of the reflector on the basis of the pair of the response signals determined by the pairing element; and a spurious processing element for processing a response appearing in the frequency spectrum due to cross modulation or intermodulation in a circuit as a spurious response. The recognition condition is a condition for determining the spurious response by the spurious processing element.

(7) The electromagnetic wave is a frequency modulated continuous wave. The detection information obtaining unit includes an element for obtaining information about projecting portions observed in a frequency spectrum of beat signals generated in an ascending modulation section and a descending modulation section of a reception signal and a transmission signal of the electromagnetic wave; a pairing element for determining a pair of response signals on the basis of a pairing condition for determining whether the response signals generated in the ascending modulation section and the descending modulation section have resulted from the same reflector; a measured value calculating element for calculating a position and speed of the reflector on the basis of the pair of the response signals determined by the pairing element; an element for treating, if a plurality of targets determined by the measured value calculating element are substantially continuously positioned and have a speed corresponding to the speed of stationary objects, an area where the plurality of targets are present as a stationary-object area; and an element for processing, as a false target, a target determined by the measured value calculating element and moving in the stationary-object area. The stationary-object area is used as the recognition condition.

With the present invention, the level of reliability of tracking a target corresponding to one and the same reflector can be determined, by the tracking reliability determining unit, on the basis of detection information obtained at a plurality of different measurement time points. Then, a condition for recognizing whether the target currently being tracked is a real target or a false target is tightened or loosened according to the tracking reliability or its change. Therefore, a recognition condition appropriate for the tracking reliability can be set. Thus, compared to the case where target recognition is always performed under the same recognition condition, erroneous target recognition can be reduced, and accuracy in target recognition can be improved.

In other words, when tracking reliability is low, a recognition condition required for recognizing a real target is tightened. This can prevent erroneous recognition in which a target that has low tracking reliability and is to be ultimately regarded as a false target is erroneously recognized as a real target, and thus can improve accuracy in target recognition. Additionally, in view of probability and statistics, an increasing tendency of tracking reliability becomes more significant as the probability that the target currently being tracked is a real target increases, while an increasing tendency of tracking reliability cannot be observed for a false target. Therefore, when an increasing tendency of tracking reliability is not shown, a condition required for tracking a real target is tightened. This can prevent erroneous recognition and improve recognition accuracy.

The allowable variation range of the position and speed of a target at each measurement time point, the range being used for determining whether the target is one and the same target, is used as the recognition condition described above. This can prevent erroneous tracking of a false target, improve reliability of target tracking, and enhance continuous tracking of a real target.

As in the case of an FMCW radar apparatus, when a frequency modulated continuous wave is transmitted and received, and pairing is performed on projecting portions resulting from the same reflector and observed in the frequency spectrum with respect to an ascending modulation section and a descending modulation section, a condition for the pairing is used as the recognition condition described above. Therefore, when tracking reliability is low or the changing tendency of the tracking reliability is not an increasing tendency, the pairing condition is tightened. This can reduce the possibility that the projecting portions are paired as false targets, prevent erroneous tracking of a false target, improve reliability of target tracking, and enhance continuous tracking of a real target.

When, at least on the basis of the positional proximity to one another, a plurality of pieces of detection information regarded as having resulted from the same reflector are processed as a single cluster, if tracking reliability is low or the changing tendency of the tracking reliability is not an increasing tendency, erroneous clustering is avoided. Therefore, reliability and continuity of the tracking of clustered targets can be improved.

When detection information included in the detection information obtained by the detection information obtaining unit, derived from one and the same reflector, and resulting from a side lobe of an antenna is processed as a virtual image by the side-lobe processing unit, and if target tracking reliability is low or the changing tendency of the tracking reliability is not an increasing tendency, a condition for determining the virtual image is tightened. This can prevent erroneous tracking of a virtual image resulting from a side lobe, and improve reliability and continuity of target tracking.

When the spurious processing element processes, as a spurious response, a response appearing in the frequency spectrum due to cross modulation or intermodulation, if target tracking reliability is low or the changing tendency of the tracking reliability is not an increasing tendency, a condition for determining a spurious response is tightened. This can prevent erroneous tracking of a spurious response and thus can prevent a real target from being missed.

If a plurality of targets determined by the measured value calculating element are substantially continuously positioned and have a speed corresponding to the speed of stationary objects, an area where the plurality of targets are present is regarded as a stationary-object area, and a target moving in the stationary-object area is processed as a false target. If the value of tracking reliability is low or the changing tendency of the tracking reliability is not an increasing tendency, the stationary-object area is narrowed. This can prevent correct pairing from being erroneously determined as mispairing.

### BRIEF DESCRIPTION OF THE DRAWINGS

FIG. 1 is a block diagram illustrating a configuration of a radar apparatus.

FIG. 2 is a block diagram illustrating relationships of a procedure of various types of signal processing, a step of determining tracking reliability, and change of recognition conditions.

FIG. 3 provides flowcharts illustrating processing procedures in a control circuit 1 and a recognition controller 30 of FIG. 1.

FIG. 4 is a graph illustrating exemplary spurious responses appearing in a frequency spectrum of a beat signal.

FIG. 5 provides graphs each showing an upbeat signal and a downbeat signal appearing in a frequency spectrum and an exemplary pairing condition.

FIG. 6 is a diagram illustrating tracking processing and continuation conditions thereof.

FIG. 7 is a flowchart illustrating a processing procedure for determining tracking reliability and setting recognition conditions.

FIG. 8 is a diagram illustrating clustering.

FIG. 9 is a graph showing an example of virtual images resulting from side lobes, and illustrates side-lobe processing.

FIG. 10 is a diagram illustrating an example of moving targets apparently moving in stationary-object areas.

FIG. 11 is a flowchart illustrating a procedure for the determination of erroneous tracking and the removal of a false target.

FIG. 12 is a graph illustrating an example of a frequency difference between an upbeat signal and a downbeat signal.

### REFERENCE NUMERALS

4 antenna
20 radar front end
   SAdetection area

### DETAILED DESCRIPTION OF THE INVENTION

A radar apparatus according to an embodiment of the present invention will now be described with reference to the drawings.

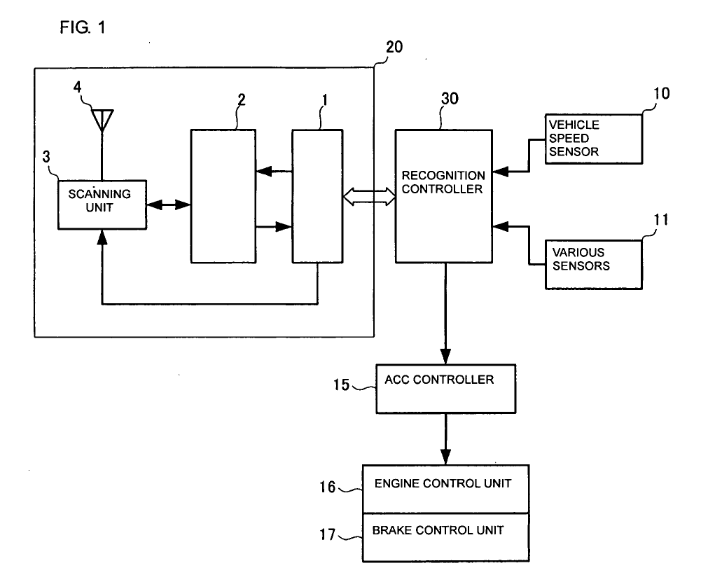

FIG. 1 is a block diagram illustrating a configuration of a system including an on-vehicle radar apparatus and various units connected thereto. Referring to FIG. 1, reference numeral 20 denotes a radar front end, which includes a control circuit 1, a millimeter wave circuit 2, a scanning unit 3, and an antenna 4. The millimeter wave circuit 2 modulates an oscillation frequency with a modulating signal supplied from the control circuit 1 as described below, and outputs a transmission signal via the scanning unit 3 to the antenna 4. Also, the millimeter wave circuit 2 supplies a reception signal, as an intermediate frequency signal (IF signal), to the control circuit 1. For example, with a mechanical reciprocating motion, the scanning unit 3 causes a beam of the antenna 4 to scan over a predetermined range.

The control circuit 1 determines the distance and speed of a target on the basis of the IF signal from the millimeter wave circuit 2, while supplying the modulating signal to the millimeter wave circuit 2. Also, the control circuit 1 outputs a control signal to the scanning unit 3 so as to direct a beam of the antenna 4 to a predetermined azimuth, and thereby causes the beam to scan a detection area in an azimuth direction and determines the azimuth of the target.

A recognition controller 30 uses signals from a vehicle speed sensor 10 and other various sensors 11 to detect conditions of the own vehicle and surroundings of a road on which the own vehicle travels. Then, the recognition controller 30 supplies information about the intended target to an ACC controller 15.

The ACC controller 15 performs automatic cruise control on the basis of the information about the target's position and speed supplied from the control circuit 1 and the vehicle's own speed determined by the vehicle speed sensor 10. For example, the ACC controller 15 supplies control data to an engine control unit 16 and to a brake control unit 17 so as to maintain a constant distance from a preceding vehicle. The ACC controller 15 also supplies control data for avoiding collision with targets ahead, including the preceding vehicle.

The engine control unit 16 and the brake control unit 17 control an engine and a brake, respectively, on the basis of the control data supplied from the ACC controller 15.

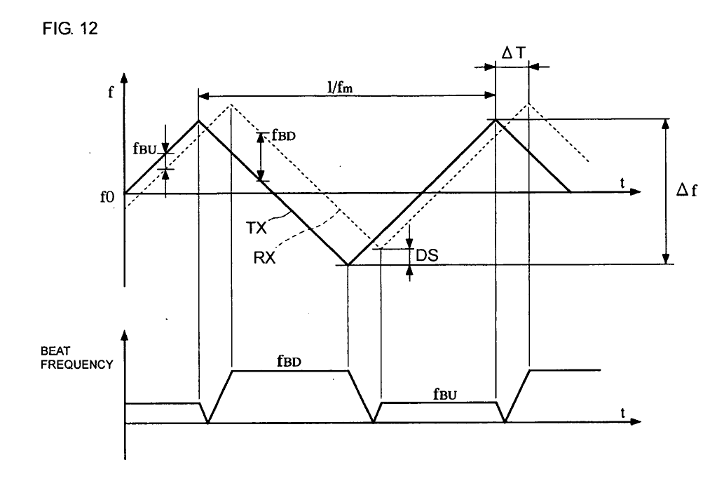

FIG. 12 illustrates an example of a shift between waveforms showing frequency changes in a transmission signal TX and a reception signal RX, the shift being caused by the distance and speed of the target. A frequency difference occurring between the transmission signal TX and the reception signal RX when the frequency of the transmission signal TX increases is an upbeat frequency f_{BU}. A frequency difference occurring between the transmission signal TX and the reception signal RX when the frequency of the transmission signal TX decreases is a downbeat frequency f_{BD}. Reference symbol Δf denotes a frequency deviation width. A difference, on the time axis, between triangular waveforms representing the transmission signal TX and the reception signal RX, in other words, a time lag ΔT corresponds to a time taken for a radio wave to travel from an antenna to the target and return. A difference between the transmission signal TX and the reception signal RX on the frequency axis corresponds to the amount of Doppler shift DS caused by the relative speed of the target with respect to the antenna. The values of the upbeat frequency f_{BU} and the downbeat frequency f_{BD} vary with the amount of time lag ΔT and Doppler shift DS. Therefore, the distance between the radar apparatus and the target, and the relative speed of the target with respect to the radar apparatus are determined by detecting the upbeat frequency f_{BU} and the downbeat frequency f_{BD}.

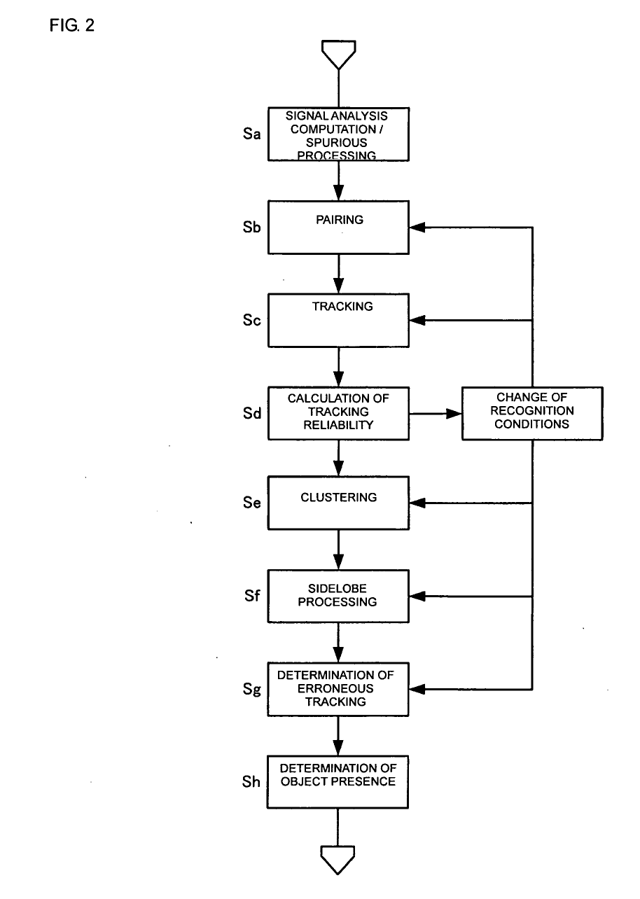

FIG. 2 illustrates a series of processing steps performed in the control circuit 1 and the recognition controller 30 of FIG. 1. FIG. 2 indicates a point at which tracking reliability is to be calculated, and recognition conditions of which processing are to be changed according to the calculated tracking reliability.

While the details of processing in each step of FIG. 2 will be described below, the overall procedure first involves determining the frequency spectrum of the upbeat signal and the downbeat signal by signal analysis, performing processing for the elimination of spurious effects (Sa), and performing pairing (Sb). This allows position and speed information about each target to be determined. Then, each target is tracked, and tracking reliability is determined with respect to each target (Sc→Sd).

Next, clustering (Se) and side-lobe processing (Sf) are performed. A determination of erroneous tracking is made (Sg). Then, detection information (including position and speed) for each target being currently tracked, excluding targets determined to have been erroneously tracked, is outputted to the ACC controller 15 illustrated in FIG. 1 (Sh).

Then, according to tracking reliability determined for each target in step Sd, recognition conditions to be used in each step are changed. For example, in step Sb, the settings of determination conditions for determining a spurious response and the settings of pairing conditions are changed. In step Se, the settings of clustering conditions are changed. In step Sc, the settings of tracking conditions (i.e., the allowable variation ranges of the position and speed of the target, the ranges being used in determining whether the target is one and the same target) are changed. In step Sf, the settings of determination conditions for determining a virtual image in the side-lobe processing are changed. In step Sg, the settings of a stationary-object area regarded as being a series of stationary objects are changed.

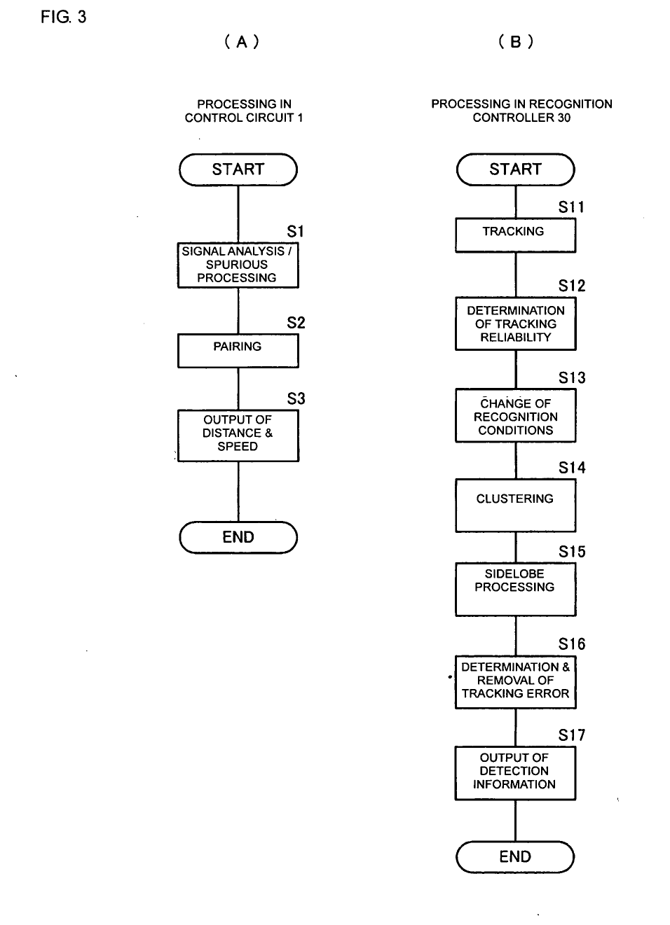

FIG. 3(A) is a flowchart illustrating the details of processing performed in the control circuit 1 in the radar front end 20 of FIG. 1. FIG. 3(B) is a flowchart illustrating the details of processing performed in the recognition controller 30.

First, a description will be made with reference to FIG. 3(A).

### <<Signal Analysis and Spurious Processing>>

The control circuit 1 controls the millimeter wave circuit 2 such that a millimeter wave signal is frequency-modulated with a triangular wave, as shown in FIG. 12, and is transmitted to a predetermined detection area. At the same time, the control circuit 1 controls the scanning unit 3 such that the detection area is scanned in the azimuth of transmission/reception beams.

Also, the control circuit 1 performs frequency analysis on beat signals. Then, at each predetermined measurement time point, the control circuit 1 extracts the peak frequency and peak value of each projecting portion observed in the frequency spectrum of an upbeat signal and a downbeat signal (S1).

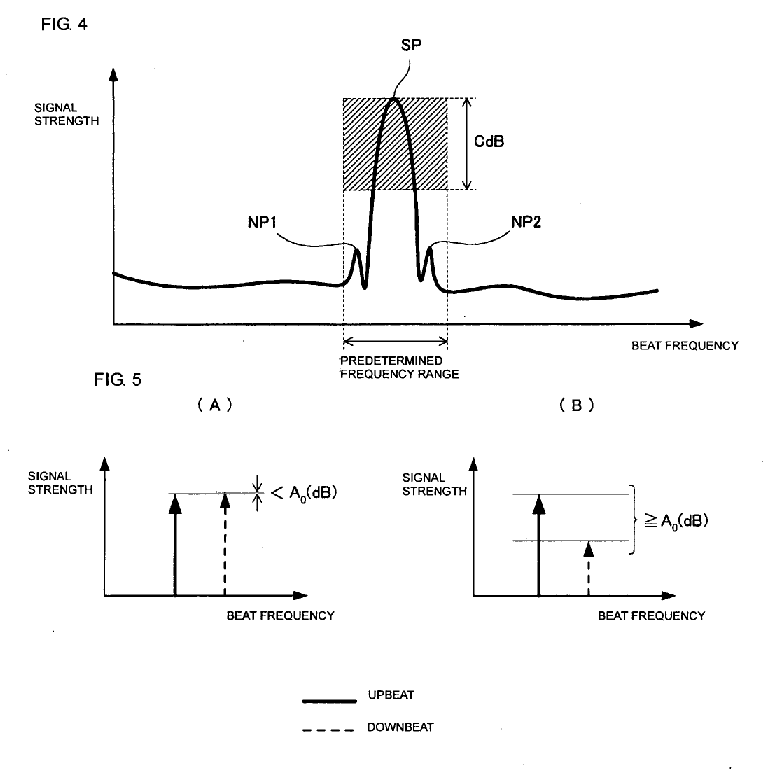

Additionally, the control circuit 1 processes spurious responses generated near a projecting portion in the frequency spectrum of a beat signal. FIG. 4 illustrates an example of the frequency spectrum. The receipt of a signal from a reflector causes a projecting portion SP of a beat signal to appear. Spurious responses NP1 and NP2 are generated near the projecting portion SP due to cross modulation and intermodulation caused by the C/N characteristics of an oscillator or other signal sources (i.e., noise from a switching power source, clock signals of a signal processing circuit, drive signals of a scanning mechanism, and the like).

Therefore, so as not to erroneously detect such a spurious response as a target, a projecting portion that is within a predetermined frequency range and has a peak value lower, by a predetermined level C (dB) or above, than an intended peak value is regarded as a spurious response and eliminated. This is done with respect to each projecting portion observed in the frequency spectrum. Then, this allowable signal strength range C (dB) is set according to tracking reliability.

<Setting Example of Spurious Processing Conditions: 1>

If, in the frequency spectrum, a projecting portion corresponding to a target with tracking reliability higher than a predetermined value is present within the range for spurious detection (i.e., the range hatched in FIG. 4), the above-described determination and elimination of the spurious response are not applied, or the predetermined signal intensity C (dB) is increased.

Thus, even if a reflector having a lower millimeter-wave reflection intensity (i.e., having a small scattering cross section), such as a human body, is present near a reflector having a higher reflection intensity, the reflector having a lower reflection intensity can be prevented from being excluded as a spurious response.

<Setting Example of Spurious Processing Conditions: 2>

Even if there is a projecting portion which appears to be a spurious response resulting from a projecting portion (hereinafter referred to as “real projecting portion”) generated in response to the receipt of a reflected signal from a reflector and observed in the frequency spectrum of a beat signal, if tracking reliability for a target which appears to correspond to the spurious response is higher than tracking reliability for a target which appears to correspond to the real projecting portion, the elimination of the spurious response is not applied, or the signal intensity C (dB) is increased.

If projecting portions have a relationship such as that described above, it is highly likely that the projecting portions have been generated by the presence of two or more tangible reflectors. Therefore, for example, even if a reflector having a lower reflection intensity is present near a reflector having a higher reflection intensity, it is possible to detect the reflector having a lower reflection intensity.

<<Pairing>>

Next, matching (i.e., pairing) of projecting portions observed in the frequency spectrum of an upbeat signal and a downbeat signal is performed (S2). Examples of pairing conditions include a peak signal strength, the degree of correlation between the shapes of respective projecting portions along the frequency axis, and the degree of correlation between the shapes of respective projecting portions in the azimuth direction. For example, as shown in FIG. 5(A), if a difference in signal strength is less than a predetermined signal-strength difference A₀ (dB), the upbeat signal and the downbeat signal are regarded as being derived from one and the same reflector, or in other words, regarded as a pair.

On the other hand, as shown in FIG. 5(B), if a difference between the strength of an upbeat signal and that of a downbeat signal is equal to or greater than A₀ (dB), these signals are regarded as being derived from different targets and not regarded as a pair.

The above-described pairing conditions are changed according to tracking reliability determined as described below, or according to the change of the tracking reliability.

<Setting Example of Pairing Conditions: 1>

If tracking reliability is low, the above-described signal-strength difference A₀ between peak signal strengths is reduced. If tracking reliability is high, the value of A₀ is increased.

If tracking reliability is low, it may be possible that previous measurement data (i.e., the position and speed of a target) is a result of erroneous detection caused by mispairing or the like. Therefore, reducing the signal-strength difference A₀ can make the mispairing less likely to occur, and significantly reduce the probability that a false target resulting from mispairing will continue to be tracked. On the other hand, if tracking reliability for a target determined as a result of paring is high, it is likely that a tangible target is being tracked. In this case, the value of the above-described A₀ is increased (i.e., the pairing condition is loosened). This can make it easier to perform tracking, prevent a target from being missed as a result of having deviated from the pairing condition, and thus improve continuity of the tracking of a real target.

<Setting Example of Pairing Conditions: 2>

If tracking reliability is low, the allowable range of azimuth difference or distance difference between projecting portions on which pairing is to be performed is reduced. If tracking reliability is high, the allowable range is increased.

If a false target resulting from mispairing is erroneously tracked, an upbeat signal and a downbeat signal erroneously regarded as a pair are derived from different targets (i.e., reflectors) or are noise signals. In this case, the positions of their corresponding projecting portions along the azimuth and on the frequency axis do not match each other. Therefore, if tracking reliability is low, the allowable range of azimuth difference or frequency difference between projecting portions on which pairing is to be performed is reduced. This significantly reduces the probability that a false target will continue to be tracked. On the other hand, if tracking reliability is high, the allowable range of azimuth difference or frequency difference between these projecting portions is increased. This can improve continuity of the tracking of a real target.

<Setting Example of Pairing Conditions: 3>

If tracking reliability is low, a threshold value for the degree of correlation between the shapes, in the azimuth direction or along the frequency axis, of projecting portions on which pairing is to be performed is increased. If tracking reliability is high, the threshold value is reduced.

As described above, if a false target resulting from mispairing is erroneously tracked, an upbeat signal and a downbeat signal that are erroneously regarded as a pair are derived from different targets (i.e., reflectors) or are noise signals. In this case, there is no correlation between the shapes of their corresponding projecting portions in the azimuth direction and along the frequency axis (i.e., the degree of correlation is very low). Therefore, if tracking reliability is low, the allowable range of difference in the degree of correlation, in the azimuth direction or along the frequency axis, between projecting portions on which pairing is to be performed is reduced. This significantly reduces the probability that a false target will continue to be tracked. On the other hand, if tracking reliability is high, the allowable range is increased. This can improve continuity of the tracking of a real target.

<<Output of Distance and Speed Information>>

As shown in step S3 of FIG. 3(A), after the completion of the pairing described above, the control circuit 1 outputs information about the distance and speed of each target to the recognition controller 30.

<<Tracking>>

FIG. 3(B) is a flowchart illustrating a processing procedure in the recognition controller 30. If a change in the position or speed of a target at every measurement time point is within a predetermined range, the target is regarded as being corresponding to one and the same reflector. This processing performed with respect to each target is tracking (S11). Examples of a change to be observed at every measurement time point include changes in speed, distance, azimuth angle, and reception signal strength (or scattering cross section). Such a tracking condition is set according to the tracking reliability or its changing tendency.

<Setting Example of Tracking Conditions: 1>

If tracking reliability is low, the allowable range of relative speed difference within which a target is regarded as being currently tracked is made narrower than that in the case where the tracking reliability is high. For example, if tracking reliability is high, the allowable range is set to ±4 km/h. On the other hand, if the tracking reliability is lower than a threshold value, the allowable range is set to ±3 km/h.

If tracking reliability for a target is low, the target is likely to be a false target resulting from mispairing caused by noise or the like. The speed of such a false target caused by noise varies considerably at each measurement time point, and thus exceeds the allowable range described above. Therefore, tracking of the target does not continue. On the other hand, if the target is a real target, the speed variation at each measurement time point is within the allowable range. Therefore, it is possible to continue tracking the target in a stable manner.

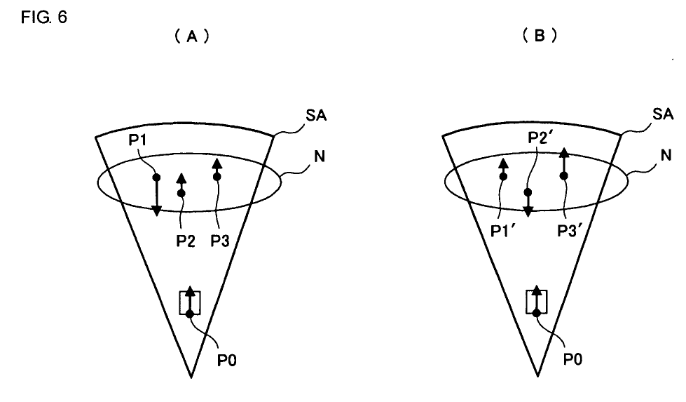

For example, FIG. 6(A) illustrates the position and speed of each target at the n-th (previous) measurement time point. FIG. 6(B) illustrates the position and speed of each target in a detection area at the (n+1)-th (current) measurement time point. In FIGS. 6(A) and 6(B), each filled circle indicates the position of a target, while each arrow indicates the direction and speed of movement of the target. In this example, a false target tends to appear particularly in an area indicated by reference character N due to the effect of noise. Although targets P1, P2 and P3 stay at substantially the same positions, their speeds of movement change significantly. Therefore, these targets are not regarded as being currently tracked. These targets are processed as targets newly detected at the (n+1)-th measurement time point. On the other hand, a target P0 stays at substantially the same position and its change in speed is within an allowable range. Therefore, the target P0 is regarded as a target being currently tracked.

<<Determination of Tracking Reliability and Change of Recognition Processing Conditions>>

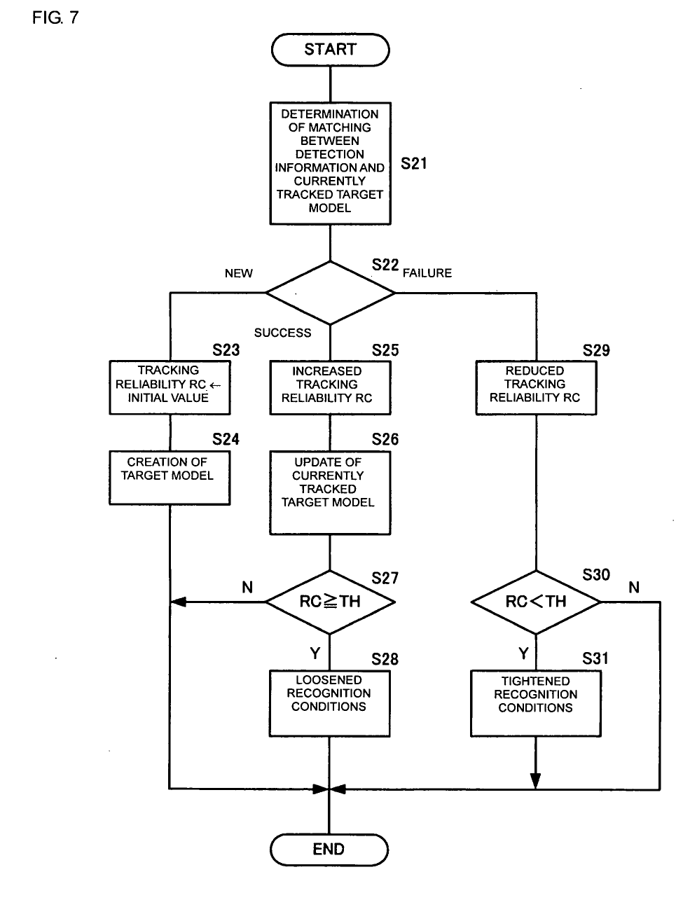

Next, tracking reliability will be determined as shown in FIG. 3(B) (S12). FIG. 7 is a flowchart illustrating the details of processing for determining the tracking reliability.

First, it is determined whether it is possible to associate detection information with a target model of a target currently being tracked (S21). The detection information includes the position and speed of a target, a reception signal strength profile along the distance of the target, and a reception signal strength profile along the azimuth of the target. The target model includes information such as the position, speed, and scattering cross section of the target currently being tracked. That is, the target motel of a target currently being tracked is information that makes it possible to predict the position and speed of the target at the next measurement time point. If a target cannot be associated with the target currently being tracked and is regarded as a new target, the initial value of tracking reliability RC is set for the new target. Then, a model is created for the new target (S22→S23→S24).

In step S21, if new detection information obtained at the current measurement time point is successfully associated with the model for the target currently being tracked, the tracking reliability RC for the target is increased (S21→S22→S25). For example, the tracking reliability RC is an integer value and is incremented by one in step S25. Then, information in the target model for the target currently being tracked is updated (S26). For example, information, including the position, speed, and scattering cross section of the target is updated to the latest value.

In step S21, if any one of a plurality of models for respective targets currently being tracked cannot be associated with new detection information obtained at the current measurement time point, the tracking reliability RC for the target corresponding to the model is reduced (S21→S22→S29). For example, one is subtracted from the value of RC.

If the tracking reliability RC exceeds a predetermined threshold value TH, recognition conditions at each of the steps described above are loosened (S27→S28). If the tracking reliability RC is below the threshold value TH, the recognition conditions are tightened (S30→S31).

<<Clustering>>

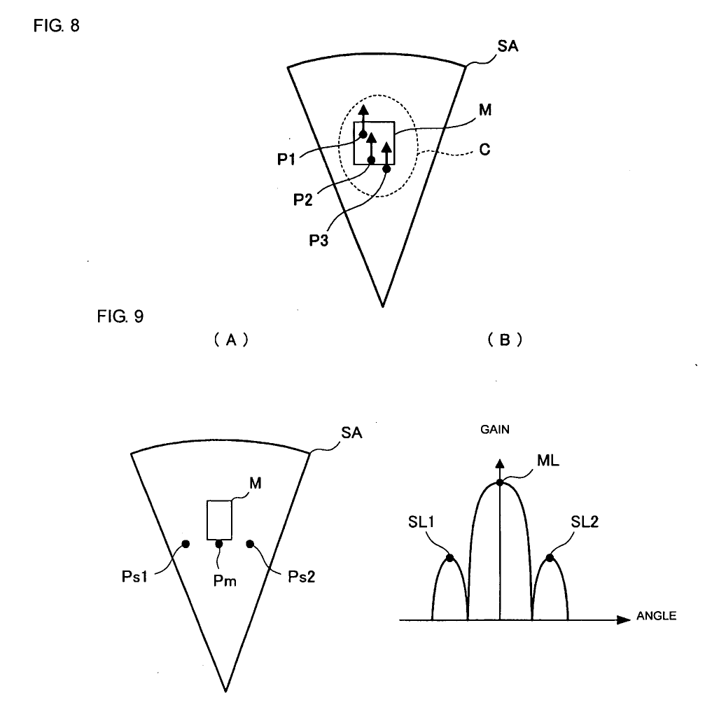

Clustering is performed as shown in FIG. 3(B). In the clustering, a plurality of pieces of detection information regarded as being derived from one and the same reflector, such as a vehicle, are processed as a single cluster (S14). For example, as illustrated in FIG. 8, if, along the azimuth and distance, the positional difference (or distance obtained through transformation into X-Y coordinates) between three targets P1, P2 and P3, out of a plurality of targets in a detection area SA, is within a predetermined allowable range, and if the relative speed difference between the three targets is also within an allowable range, these three targets are detected as a single cluster (i.e., these three targets are clustered).

In the example illustrated in FIG. 8, the position of the target P3 closest to the own vehicle is used as the position of this cluster C. Tracking reliability is determined individually for each target. Of tracking reliability values determined for the three targets P1, P2 and P3, the highest value is treated as the tracking reliability for the cluster C. Then, the clustering conditions are set on the basis of this integrated tracking reliability.

<Setting Example of Clustering Conditions: 1>

When targets that are present within a predetermined distance are selected as candidates for being clustered, if a relative speed difference between a plurality of targets before being clustered is within an allowable range of ±(V₀+α) [km/h], the plurality of targets are regarded as a single cluster. In this case, if tracking reliability is high, the value of α is increased. If tracking reliability is low, the value of α is reduced.

Clustering conditions are set in such a manner as described above. Therefore, when there is a target with high tracking reliability in the candidates for being clustered, clustering can be performed successfully even if there is a target with poor relative-speed accuracy due to the effect of noise or the like. At the same time, it can be prevented that targets with low tracking reliability (i.e., false targets) only are clustered.

The value of α describe above is typically defined individually for each target before being clustered. Alternatively, an allowable range a defined for one particular target, the range a being the largest of those for a plurality of targets that are candidates for being clustered, may be applied to all the plurality of targets.

Tracking reliability is typically defined individually for each target before being clustered. Alternatively, tracking reliability determined on the basis of the sum or product of tracking reliability values for a plurality of targets that are candidates for being clustered may be set as tracking reliability that is common to the plurality of targets.

<Setting Example of Clustering Conditions: 2>

When one or both the position and speed of a detected target are smoothed with a time-series filter, such as an α-β filter, if targets with high tracking reliability are to be clustered, the relative speed difference is set to ±(V₀−α) km/h, where α is a positive value not exceeding V₀. If tracking reliability is high, the value of α is increased. If tracking reliability is low, the value of a is reduced.

When one or both the position and speed of a detected target are smoothed with a time-series filter, such as an α-β filter, the effect of the filter contributes to improved accuracy of the speed of a target with high tracking reliability. Therefore, by setting clustering conditions as described above, if two or more targets with high tracking reliability have approached each other (e.g., in the case where one of two vehicles running in front of the own vehicle has passed the other vehicle or the two vehicles have passed each other), such targets can be prevented from being erroneously clustered.

<<Side-Lobe Processing>>

Next, side-lobe processing is performed as shown in FIG. 3(B) (S15).

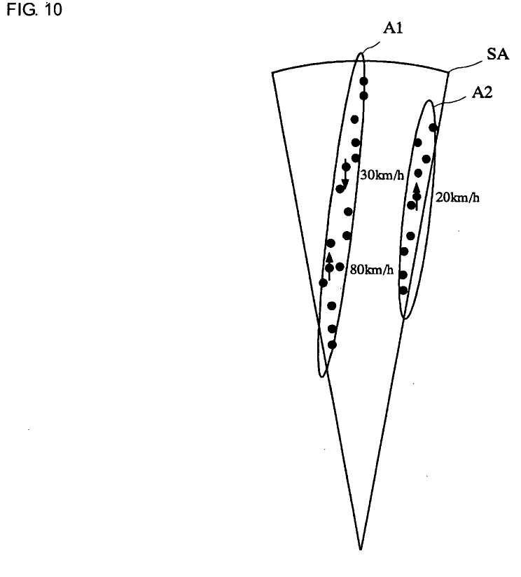

FIG. 9 illustrates the side-lobe processing. FIG. 9(A) shows the position of a vehicle M that is present in a detection area. FIG. 9(B) illustrates antenna directivity in the azimuth direction. As illustrated in FIG. 9(B), because of antenna characteristics, the gain of a central main lobe ML is highest, while the gain of side lobes SL1 and SL2 and the like appearing symmetrically on both sides of the main lobe ML is lower than that of the main lobe ML. Therefore, a target Pm resulting from the main lobe of the antenna appears as illustrated in FIG. 9(A), while targets Ps1 and Ps2 resulting from the two side lobes of the antenna appear on both sides of the target Pm.

The gain ratio (or “difference” in decibels) between the main lobe ML and the side lobe SL1 or SL2 is fixed. At the same time, the azimuth angle from the front of the antenna to the side lobe SL1 or SL2 is fixed. Of a plurality of targets appearing in the detection area as illustrated in FIG. 9(A), targets resulting from the side lobes are thus regarded as false targets (i.e., virtual images) on the basis of the relationships described above. Then, processing is performed such that tracking of the targets resulting from the side lobes do not continue. Specifically, if there are projecting portions located at the same distance and in a predetermined range corresponding to an angular difference between side lobes on both sides of the main lobe (i.e., the center of the main lobe), and if a reception signal strength at each projecting portion is lower than that in the main lobe by a value equivalent to the square of the gain difference between the main lobe and a side lobe, the projecting portions are regarded as corresponding to virtual images resulting from the side lobes.

<Setting Example of Detection Conditions for Detecting Virtual Image Resulting from Side Lobe: 1>

Then, if tracking reliability for a target detected in the main lobe is lower than a predetermined value, the error of angular range for detecting a virtual image resulting from a side lobe is made smaller to tighten the condition. Also, side-lobe processing itself is not performed.

If it is possible that detection information about a target having apparently been detected by the main lobe is derived from erroneous detection, in other words, if it is possible that the target is a false target, a determination as to whether targets on both sides of the target having apparently been detected by the main lobe are virtual images or real images (i.e., false targets observed when, by coincidence, an angular difference from noise satisfies a condition for recognizing erroneous detection caused by side lobes) is suspended. Thus, it can be prevented that, if a target having apparently been detected by the main lobe turns out to be a false target, real targets positioned on both sides of the false target and resulting from small reflectors are removed as virtual images caused by the side lobes.

<Setting Example of Detection Condition for Detecting Virtual Image Resulting from Side Lobe: 2>

Even when relationships between projecting portions seem to correspond to those between the main lobe and side lobes in terms of distance, difference in azimuth angle, and difference in reception signal strength, if tracking reliability for targets having apparently been detected by the side lobes is higher than tracking reliability for a target having apparently been detected by the main lobe, side-lobe processing is not performed on the targets having apparently been detected by the side lobes.

Normally, it is less likely that tracking reliability for targets detected by side lobes exceeds tracking reliability for a target detected by a main lobe. If there is such a case, the targets having apparently been detected by the side lobes are likely to have resulted from a reflector detected by the main lobe, and are not likely to be targets detected by the side lobes. Thus, by setting the condition described above, it can be prevented that a tangible reflector (i.e., real target) is erroneously recognized as a virtual image.

<Setting Example of Detection Conditions for Detecting Virtual Image Resulting from Side Lobe: 3>

When relationships between projecting portions seem to correspond to those between the main lobe and side lobes in terms of distance, difference in azimuth angle, and difference in reception signal strength, and if tracking reliability for a target having apparently been detected by the main lobe is higher, by a value equal to or greater than a predetermined value, than tracking reliability for targets having apparently been detected by the side lobes, an allowable range for recognizing erroneous detection caused by side lobes (i.e., allowable ranges of distance, difference in azimuth angle, and difference in reception signal strength) is increased.

If targets have the above-described relationship in terms of the level of tracking reliability, it is highly likely that the relationship corresponds to a relationship between a real image resulting from a main lobe and virtual images resulting from side lobes. Thus, by loosening the conditions for recognizing erroneous detection caused by side lobes, recognition of erroneous detection caused by side lobes can be performed correctly and continuously. Also, tracking of a real target can be continuously performed with high reliability.

<<Determination and Removal of Tracking Error>>

Subsequently, the determination of erroneous tracking and the removal of a false target will be performed as shown in step S16 of FIG. 3(B). Specifically, if some of a plurality of measured targets are positioned substantially continuously and each target has a speed corresponding to that of a stationary object (i.e., each target approaches the own vehicle at the same speed as that of the own vehicle), an area in which such targets are present is regarded as a stationary-object area. Then, of the plurality of measured targets, a target moving in the stationary-object area is regarded as a target that is erroneously being tracked.

FIG. 10 illustrates the situation described above. Since an area where there are a plurality of targets determined to be substantially continuous stationary objects corresponds to a guardrail, a noise abatement wall, a median strip, a building wall, or the like, a moving object is normally not present in such an area. Therefore, if a target currently being tracked is moving in such a stationary-object area A1 or A2 at a speed different from that of a stationary object, the target can be regarded as a false target resulting from mispairing or the like and currently being erroneously tracked.

Referring to FIG. 10, targets apparently present in the stationary-object area A1 and having speeds of 30 km/h and 80 km/h are removed as false targets erroneously being tracked. Likewise, a target apparently present in the stationary-object area A2 and having a speed of 20 km/h is removed as a false target erroneously being tracked.

Then, a condition for the recognition of erroneous tracking (i.e., the size of an area to be used for determining that a target is present near a stationary object) is set according to tracking reliability.

<Setting Example of Erroneous-Tracking Determining Conditions: 1>

For a target having a tracking reliability of equal to or greater than a predetermined value and regarded as a stationary object, a moving object present in a range of ±5 m in the own-vehicle's moving direction (i.e., along the distance) and ±2 m in the right-and-left direction (i.e., along the road width) of the stationary-object area is determined to be a false target resulting from mispairing. As for a target having a tracking reliability of less than a predetermined value and regarded as a stationary object, a moving object present in a range of ±2 m in the own-vehicle's moving direction (i.e., along the distance) and ±1 m in the right-and-left direction (i.e., along the road width) of the stationary object is determined to be a false target resulting from mispairing.

Thus, a target having lower tracking reliability and regarded as a stationary object is highly likely to be a false target resulting from erroneous detection due to noise. In this case, with the condition described above, a range for the determination of mispairing is reduced. Therefore, erroneous tracking, such as continuous tracking of a false target, can be prevented. As for a target with higher tracking reliability, the range for the determination of mispairing is relatively wide. This enhances continuous tracking of a real target currently being tracked.

<Setting Example of Erroneous-Tracking Determining Conditions: 2>

For a moving target with tracking reliability below a predetermined value, a moving object present in a range of ±5 m in the own-vehicle's moving direction (i.e., along the distance) and ±2 m in the right-and-left direction (i.e., along the road width) of a stationary-object area is determined to be a false target resulting from mispairing. As for a moving object with tracking reliability equal to or greater than a predetermined value, a moving target present in a range of ±2 m in the own-vehicle's moving direction (i.e., along the distance) and ±1 m in the right-and-left direction (i.e., along the road width) of a stationary object is determined to be a false target resulting from mispairing.

Thus, if a moving target with high tracking reliability is running near a roadside object, it can be prevented that the moving target is determined to be a target erroneously being tracked.

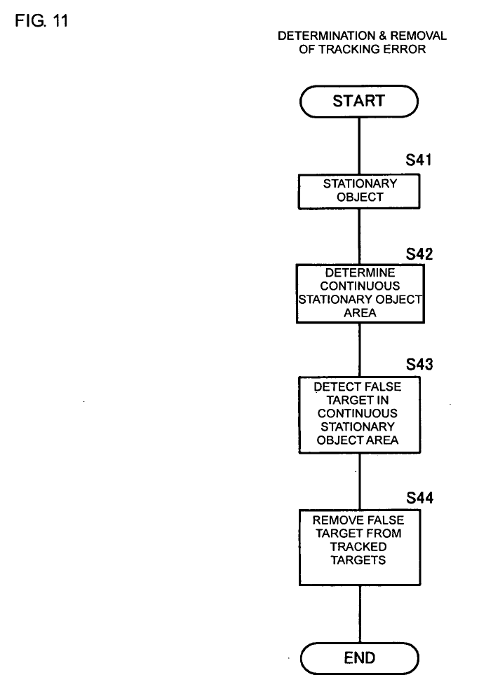

FIG. 11 is a flowchart illustrating a procedure for the determination of erroneous tracking and the removal of the corresponding target. First, stationary objects are detected from a plurality of targets (S41). Next, an area where the stationary objects are substantially continuously present is determined to be a stationary-object area (S42). Next, of the targets present in this stationary-object area, a target present in a range for the determination of mispairing is detected as a false target, in other words, a target currently being erroneously tracked (S43). Then, the detected target is removed from the targets currently being tracked.

<<Output of Detection Information>>

After the completion of the processing described above, as shown in step S17 of FIG. 3(B), detection information (including the position along the azimuth and distance, and the speed) for each of the targets currently being tracked and not having been determined to be targets erroneously being tracked is output to an upper-level host system (e.g., the ACC controller 15 of FIG. 1).

Regardless of whether the target is a real target or a false target, tracking reliability is determined with respect to each target. Therefore, when pairing is performed, information (i.e., peak frequency and peak value) about a pair of projecting portions from which targets corresponding to the determined tracking reliability are derived is all stored. Thus, when pairing is performed next time, the previous projecting portions and the current projecting portions are identified. Then, a pairing condition is applied to a pair of projecting portions of an upbeat signal and a downbeat signal if the pair is identical to a pair of the previous projecting portions.

If the three targets Pm, Ps1, and Ps2 illustrated in FIG. 9 are clustered, side-lobe processing is performed on the cluster basis.

In the examples described above, a recognition condition for each processing is changed depending on whether the value of tracking reliability for a target exceeds a predetermined threshold value. Alternatively, tracking reliability for each target may be determined at each measurement time point, and the recognition condition may be changed depending on whether the changing tendency of the tracking reliability is an increasing tendency. In other words, if an increasing tendency of the tracking reliability is not observed, a recognition condition required for recognizing a real target is set to be tightened. This can prevent a false target from being continuously tracked, improve reliability of target tracking, and enhance continuous tracking of a real target.

Additionally, although a recognition condition is changed in two stages in the examples described above, the condition may be changed in multiple stages or may even be changed substantially linearly.

1. A radar apparatus comprising:
a detection information obtaining unit that obtains detection information including at least one of a position or a speed of a reflector in a predetermined detection area, the detection information obtaining unit transmitting and receiving an electromagnetic wave to and from the detection area at predetermined measurement time points;
a tracking reliability determining unit that tracks a target corresponding to the reflector based on the detection information at a plurality of different measurement time points of the predetermined measurement time points, the tracking reliability determining unit further determining a tracking reliability indicating a likelihood that the target being tracked corresponds to the reflector; and
a recognition condition setting unit that sets a recognition condition for recognizing the target, wherein the recognition condition is tightened if the tracking reliability is below a predetermined value or if an increasing tendency of the tracking reliability is not observed.

2. The radar apparatus according to claim 1, wherein the recognition condition is an allowable variation range of the at least one of the position and the speed of the target at each predetermined measurement time point, the allowable variation range being used for determining whether the target being tracked corresponds to the reflector.

3. The radar apparatus according to claim 1, wherein the electromagnetic wave is a frequency modulated continuous wave.

4. The radar apparatus according to claim 3, wherein the detection information obtaining unit comprises:
an element for obtaining information about projecting portions in a frequency spectrum of beat signals generated in an ascending modulation section and a descending modulation section of a reception signal and a transmission signal of the electromagnetic wave;
a pairing element for obtaining a pair of response signals from the ascending modulation section and the descending modulation section on the basis of a pairing condition, the pairing condition determining whether the response signals in the ascending modulation section and the descending modulation section have resulted from the same reflector; and
a measured value calculating element that calculates the at least one of the position and the speed of the reflector on the basis of the pair of the response signals

5. The radar apparatus according to claim 4, wherein the recognition condition is the pairing condition.

6. The radar apparatus according to claim 1, further comprising a clustering unit for processing, as a single cluster, a plurality of pieces of detection information determined to have resulted from the same reflector, on the basis of a clustering condition which at least defines positional proximity of the plurality of pieces of detection information to one another; and the recognition condition is the clustering condition.

7. The radar apparatus according to claim 1, further comprising a side-lobe processing unit for processing, as a virtual image, the detection information obtained by the detection information obtaining unit, derived from the same reflector, and resulting from a side lobe of an antenna capable of transmitting and receiving the electromagnetic wave; and wherein the recognition condition is a condition for determining the virtual image by the side-lobe processing unit.

8. The radar apparatus according to claim 3, wherein the detection information obtaining unit comprises:
an element for obtaining information about projecting portions observed in a frequency spectrum of beat signals generated in an ascending modulation section and a descending modulation section of a reception signal and a transmission signal of the electromagnetic wave;
a pairing element for obtaining a pair of response signals from the ascending modulation section and the descending modulation section on the basis of a pairing condition, the pairing condition determining whether the response signals in the ascending modulation section and the descending modulation section have resulted from the same reflector;
a measured value calculating element for calculating the position and the speed of the reflector on the basis of the pair of the response signals obtained by the pairing element; and, a spurious processing element for processing a response appearing in the frequency spectrum due to cross modulation or intermodulation in a circuit as a spurious response, and
wherein the recognition condition is a condition for determining the spurious response by the spurious processing element.

9. The radar apparatus according to claim 3, wherein the detection information obtaining unit comprises:
an element for obtaining information about projecting portions observed in a frequency spectrum of beat signals generated in an ascending modulation section and a descending modulation section of a reception signal and a transmission signal of the electromagnetic wave;
a pairing element for obtaining a pair of response signals from the ascending modulation section and the descending modulation section on the basis of a pairing condition, the pairing condition determining whether the response signals in the ascending modulation section and the descending modulation section have resulted from the same reflector;
a measured value calculating element for calculating the position and the speed of the reflector on the basis of the pair of the response signals determined by the pairing element; an element for treating an area where a plurality of targets are present as a stationary-object area if the plurality of targets are substantially continuously positioned and have a speed corresponding to the speed of stationary objects; and
an element for processing a target determined by the measured value calculating element and determined to be moving in the stationary-object area as a false target, and
wherein the stationary-object area is used as the recognition condition.
